(19) United States
(12) Patent Application Publication
(10) Pub. No.: US 2026/0177449 A1
(43) Pub. Date: Jun. 25, 2026

(54) DEVICE AND METHOD FOR TESTING ELONGATE TEST SPECIMENS

(71) Applicant: Fraunhofer-Gesellschaft zur Förderung der angewandten Forschung e.V., München (DE)

(72) Inventors: Malo Rosemeier, Bremen (DE); David MELCHER, Bremen (DE); Bernd HALLER, Bremen (DE); Christian MEYER, Bremen (DE)

(21) Appl. No.: 19/127,941

(22) PCT Filed: Nov. 10, 2023
(86) PCT No.: PCT/EP2023/081463

§ 371 Date: May 7, 2025

(30) Foreign Application Priority Data
Nov. 11, 2022 (DE) 10 2022 211 982.7

(51) Int. Cl. G01M 5/00

(52) U.S. Cl. CPC G01M 5/0058; G01M 5/0016; G01M 5/0066

(57) ABSTRACT

The invention relates to a device for testing an elongated test specimen (1). This comprises a tensioning device (2) to clamp the test specimen (1) such that it extends lengthwise from the tensioning device (2) in a longitudinal direction with a horizontal direction component. It also includes at least one actuator (5A, 5B) to deflect the test specimen (1), at least one cable (12), a first deflection roller (13A) arranged on a first side of the test specimen (1), so that a first cable section of at least one cable (12) can be guided over the first deflection roller to a first lateral point of application on the test specimen (1) or a load frame (4) for the test specimen (1) and can be connected to the first point of application, and a second deflection roller (13B) arranged on a second side of the test specimen (2) opposite the first side, so that a second cable section (12L) of the at least one cable (12) can be guided over the second deflection roller to a second lateral point of application on the test specimen (1) or the load frame (4) for the test specimen (1) and can be connected to the second point of application, the second lateral point of application being opposite the first lateral point of application. The device also includes at least one tensioning device (18) to tension the first and second cable sections. The invention relates to a system as well as a method for testing an elongated test specimen.

The invention resides in the field of mechanical engineering. It relates to a device and method for testing elongated test specimens. It is particularly advantageous for use in wind energy technology, especially for testing entire rotor blades or rotor blade segments of wind turbines.

As blade lengths continue to increase, structurally testing elongated, slim test specimens, such as entire rotor blades or rotor blade segments of wind turbines, is becoming a challenge. The structural test is preferably carried out cyclically and in resonance, whereby it can provide excitations in the edgewise direction and/or flapwise direction. The longer a test specimen, the lower its natural frequency is and the longer the test lasts. Therefore, this also prolongs the time for a new type of rotor blade for a wind turbine, for example, to be awarded certification and approval to enter operation, which results in setbacks in implementating the energy transition towards CO2-neutral energy production.

Attaching elastic elements to the test specimen, for example, and thus increasing the system natural frequency, is a way to overcome this challenge. For example, DE 10 2018 218 515 A1 discloses a method in which at least two active load-introducing means are provided which each act on a load frame, wherein a first of the at least two active load-introducing means is configured to introduce load in a edgewise direction of the rotor blade and a second of the at least two active load-introducing means is configured to introduce load in an flapwise direction of the rotor blade. Furthermore, at least one passive load introduction means is provided in accordance with DE 10 2018 218 515 A1, wherein for a system which comprises the rotor blade and the at least one passive load-introducing means, a system natural frequency for the edgewise direction and/or for the flapwise direction is changed by the at least one passive load-introducing means.

However, one problem remains: as test specimens become longer and longer, the deflection in the flapwise direction of test specimen's tip area becomes so great that devices with elastic elements lead to very long displacements and/or deflections of the elastic elements and, consequently, very long elastic elements are required. This makes the elastic elements very heavy and they may act as resonant masses, their weight counteracting the desired spring effect.

Minimising the overload is another challenge, i.e., deviating from the test bending moment distribution from the test bending moment distribution, increasingly longer test specimens. This challenge can be counteracted, for example, by attaching masses in the test specimen's tip area for a test in the edgewise direction. The disadvantage of this is that the masses to be attached must often be very large, causing a surpass in the permissible transverse forces in the flapwise direction, which, due to the weight force of these masses during a test in the edgewise direction, increases the mean bending moment distribution to an impermissible extent or, due to the large deflection at the tip, cause the introduction of an impermissible torsional moment. Decoupling masses from the test specimen can help. These then only work in one preferred direction, e.g. in the edgewise direction. In the event of biaxial stimulation, it has been found to be advantageous to use decoupled masses acting in the edgewise direction and elastic elements acting in the flapwise direction to tune the system natural frequencies to one another, for example in ratios of 1:1, 1:2, etc. (see DE 10 2018 218 515 A1), therefore enabling both directions to be tested simultaneously and thus a total time saving of the test programme consisting of several test sequences of edgewise and flapwise tests.

One problem, however, may be that the deflection in the flapwise direction of increasingly longer test specimens in conventional devices with decoupled masses becomes so great at the tip that, to be able to minimise parasitic forces (which do not act in the desired direction), very long rods are needed to due to large angles, Long rods, however, run the risk of becoming unstable and introduce an additional inertia into the system that also does not work in the preferred direction and is not therefore wanted.

It is the object of the present invention to further improve the known systems and methods and to solve at least some of the above-mentioned problems.

This is solved by a device to test an elongated test specimen according to claim 1. Furthermore, the task is solved by a system or a method according to one of the independent claims. The dependent claims and the following description and figures result in advantageous embodiments.

A device to test an elongated test specimen therefore comprises a clamping device to clamp the test specimen such that it extends from the clamping device lengthwise in a longitudinal direction with a horizontal directional component.

The device also includes at least one actuator to deflect the test specimen.

The device also includes at least one cable.

The device also includes a first deflection roller, which is arranged on a first side of the test specimen so that a first cable section of the at least one cable can be guided over the first deflection roller to a first lateral point of application on the test specimen or a load frame for the test specimen and can be connected to the first point of application.

The device also includes a second deflection roller, which is arranged on a second side of the test specimen, opposite the first side, enabling a second cable section of the at least one cable to be guided over the second deflection roller to a second lateral point of application on the test specimen or the test specimen's load frame and can be connected to the second point of application, the second lateral point of application being opposite the first lateral point of application.

The device also includes at least one tensioning device for tensioning the first and second cable sections.

The device is a useful solution to the above-mentioned problem. The at least one cable, guided over the deflection rollers, allows a favourable control of the test specimen and has an effect on the test specimen. One special feature is that the effect for a movement along the cable sections connected to the test specimen, on the one hand (e.g. horizontally), and for a movement perpendicularly to the cable sections connected to the test specimen on the other hand, can be differently designed. This means, for example, that specific loads can be configured for the flapwise direction and/or the edgewise direction. These special properties of the device will be explained in more detail below.

A proposed system for testing an elongated test specimen includes the device presented here and the test specimen, which can, for example, be a rotor blade or a rotor blade segment of a wind turbine. The test specimen is clamped in the clamping device so that it extends lengthwise from the clamping device in the longitudinal direction with the horizontal directional component, the first cable section being connected to the first lateral point of application and the second cable section connected to the second point of application.

A proposed method to test a test specimen occurs using the said system, whereby the test specimen is deflected via the at least one actuator and the first and second cable sections are tensioned by the at least one tensioning device.

Typically, a cyclic strain is applied in the flapwise and/or edgewise direction, or in the vertical and/or horizontal direction.

It should be emphasised that features described here in connection with the device or the system can also count for the method, and vice versa.

In one example, the at least one actuator includes a first actuator to deflect the test specimen in a first deflection orientation and a second actuator to deflect the test specimen in a second deflection orientation transverse to the first deflection orientation.

For example, the at least one actuator includes a vertical actuator to deflect the test specimen with a vertical directional component. The vertical directional component can, for example, correspond to the flapwise direction of a wind turbine's rotor blade to be tested. When the test specimen is deflected in this direction, which typically runs transversely to the cable, tension is exerted on the first cable section and the second cable section if the first and second cable sections are connected to the test specimen. In one possible embodiment, the at least one tensioning device tensions the first and second cable sections such that a restoring force is exerted on the deflected test specimen. This enables the deflection in the vertical direction (e.g. flapwise direction) via the cable to be particularly well controlled. The method may accordingly provide that the test specimen is deflected in a direction with a vertical directional component, with the at least one cable exerting a restoring force on the vertically deflected test specimen. This effect is roughly equivalent to the way an elastic element works, as described above.

Alternatively or additionally, the at least one actuator includes a horizontal actuator to deflect the test specimen in a second deflection orientation with a horizontal directional component. This could, for example, be the edgewise direction of a wind turbine's rotor blade to be tested. Essentially, the horizontal deflection typically occurs along the cable. In some embodiments, the cable can be arranged such that it tolerates this type of deflection by running freely and, for example, not exerting any restoring force on the test specimen. In some possible embodiments, inert masses can be arranged on the cable which then move with the cable during deflection and the resulting inertial forces act on the test specimen via the cable. One embodiment of the method may provide for the test specimen to be deflected in a direction with a horizontal directional component, and for the at least one cable to tolerate the horizontal deflection. In response to the deflection, the cable runs over the first and second deflection rollers. Optionally, the deflection can be influenced by at least one movable mass connected to the at least one cable. This effect corresponds approximately to the effect of a decoupled mass as described above. Special configurations of this option are explained in more detail below.

The at least one cable can, for example, be designed as a wire cable or as a plastic cable. The at least one cable can, for example, contain Dyneema® fibre.

For example, the at least one cable may include a first cable and a second cable. It may be the case that the first cable section is a section of the first cable, so that the first cable can be attached to the first point of application, and the second cable section is a section of the second cable, so that the second cable can be attached to the second point of application. The device may have a first cable attachment for attaching the first cable and a second cable attachment for attaching the second cable. The at least one tensioning device can then comprise a first tensioning device and a second tensioning device, wherein the first tensioning device engages the first cable between the first deflection roller and the first cable attachment and the second tensioning device engages the second cable between the second deflection roller and the second cable attachment. In such embodiments, there are at least two cables attached to the test specimen, which are additionally fixed. These arrangements may be designed, for example, to influence a vertical deflection and/or serve a targeted application of force in the horizontal direction by controlling and/or regulating the individual tensioning devices.

As an alternative to the additionally fixed cables, embodiments are envisaged in which the cable can run freely or under the influence of moving masses, as briefly indicated above. In this case, the at least one cable may include a first cable, where both the first cable section and the second cable section are sections of this first cable. So the first cable is then guided over the first deflection roller and the second deflection roller and can be connected to the first and second points of application. Likewise, the at least one cable may comprise a first cable and a second cable, the first cable section being a section of the first cable and the second cable section being a section of the second cable, the first and second cables being connected to each other. The two cables can then move in synchronisation. This variant can be equivalent in function to the single cable variant, where two interconnected parts are used instead of one cable. In other words, the cable is interrupted or cut, which means, for example, that objects such as inert masses can be arranged in between. Of course, the inert masses can also be attached to a single cable, e.g. using cable clamps.

In particular, one possible embodiment envisages that the at least one cable is connected to at least one movable mass. This movable mass can act as an inert mass on the cable and thus on the test specimen upon deflection. The movable mass can be designed as a directionally decoupled mass, which, for example, only influences the test specimen's deflection in a certain direction, e.g. the horizontal direction.

As briefly mentioned above, the movable mass can be set in motion in particular by the cable running over the rollers when the test specimen is deflected horizontally, for example, and thus being displaced in length.

The movable mass can be arranged, for example, such that it experiences a movement when the test specimen is deflected with a component in one direction along the cable, for example with a horizontal component, which causes an asymmetrical tension on the first cable section and second cable section. The movable mass can, for example, be arranged such that it is not displaced when the test specimen is subjected to a purely vertical deflection, so that it has no influence on vertical deflection but only acts on the test specimen when it is subjected to deflections with a horizontal directional component.

The at least one movable mass can, for example, be mounted such that it can swing via a hinge and/or be connected to the at least one cable via a lever arm and/or an angled beam. The at least one movable mass can also be mounted so that it can slide along the at least one cable, for example. For example, it can be mounted on rollers or runners or rails.

The movable mass can be arranged on a horizontal carriage, for example. It then acts as an inert mass, independent of its deflection but dependent on its speed and acceleration. An inertial force caused by the inert mass is applied to the cable. Due to the force of gravity engaging on the mass's weight force, it has no influence in this arrangement. Alternatively, the movable mass can be mounted on an inclined surface, for example, and thus not horizontally. It can also be configured such that a component of the weight force acts on the cable, thereby exerting a constant deflecting force in one direction on the test specimen. The movable mass can be arranged, for example, such that a weight force acts on the movable mass, causing a static tension at the first or second lateral point of application, by which the test specimen can undergo, for example, a constant deflection towards the tension. In other words, arranging the masses as such results in a component of the weight force of the movable mass engaging on the cable, thereby causing a static tension at the first or second lateral point of application, by which the test specimen can, for example, undergo a constant deflection in the direction of the tension.

The movable mass may comprise one or more horizontally movable masses. For example, one or more masses can be mounted in a way that provides support so that a weight force engaging on the movable mass(es) does not cause any tension at the first or second lateral point of application. The movable mass can, for example, be limited to one or more such movable masses, so that overall there is no weight-force-induced tension.

For example, the at least one cable can be configured such that it runs from the first lateral point of application to the first deflection roller, whereby, from the angle of the test specimen, the movable mass and the tensioning device act on the at least one cable after the first deflection roller, and whereby the at least one cable runs after the movable mass and the tensioning device to the second deflection roller and then runs from the second deflection roller to the second lateral point of application.

The case may occur that the at least one tensioning device comprises a first tensioning device and a second tensioning device, wherein the at least one cable may be configured such to run from the first lateral point of application to the first deflection roller, wherein, viewed from the test specimen, the at least one cable is first engaged by the first tensioning device after the first deflection roller, then the at least one movable mass acts on the at least one cable, then the second tensioning device acts on the at least one cable and the cable then runs from the second tensioning device to the second deflection roller and finally from the second deflection roller to the second lateral point of application.

The at least one tensioning device can, for example, comprise a tensioning actuator, which can be designed, for example, as an electric, hydraulic or pneumatic actuator. Alternatively or additionally, the at least one tensioning device can comprise a motor and/or a cable winch and/or a spring and/or a leaf spring and/or a turnbuckle and/or one or more deflection rollers and/or a pulley. Alternatively or additionally, any possible tensioning device may, for example, comprise a tensioning screw or double nut with a right-hand and an opposing left-hand thread to tension the cable by shortening its overall length.

The at least one tensioning device can be designed as an active tensioning device comprising a motor and/or an actuator, wherein the motor and/or the actuator can be controllable and/or adjustable.

It may be the case that the first deflection roller and the second deflection roller are arranged at the same height.

The device can, for example, be configured such that the test specimen extends in an undeflected state through a connecting line from the first deflection roller to the second deflection roller, so that the first cable section and the second cable section can be connected to the test specimen such that a tension transmitted by the first cable section and tension transmitted by the second cable section engage in opposite directions, in particular in exactly opposite directions. A tension applied by the tensioning device to the two cable ends is then compensated for in the rest position, for example, where the tension applied by the tensioning device can begin to act on the two cable sections as soon as there is a deflection of the test specimen whose direction of movement does not match the alignment of the undeflected cable sections.

The device can, for example, be configured such that the test specimen extends in an undeflected state through a connecting line from the first deflection roller to the second deflection roller, so that the first cable section and the second cable section can be connected to the test specimen such that any tension applied by the first cable section and any tension applied by the second cable section exert a preload, in particular in a direction with a vertical directional component, on the non-deflected test specimen. Then, for example, a vertical force can be applied to the test specimen in the rest position via the at least one clamping device.

With the help of figures and examples, the invention is explained below. These show:

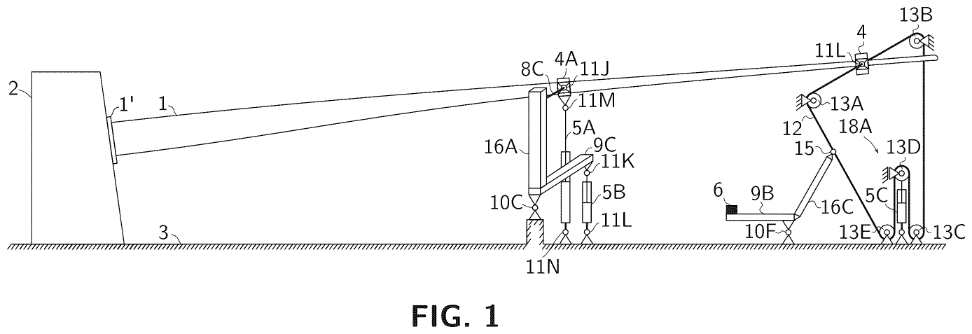

FIG. 1 a test arrangement to test a rotor blade of a wind turbine, with a cable guided over two deflection rollers,

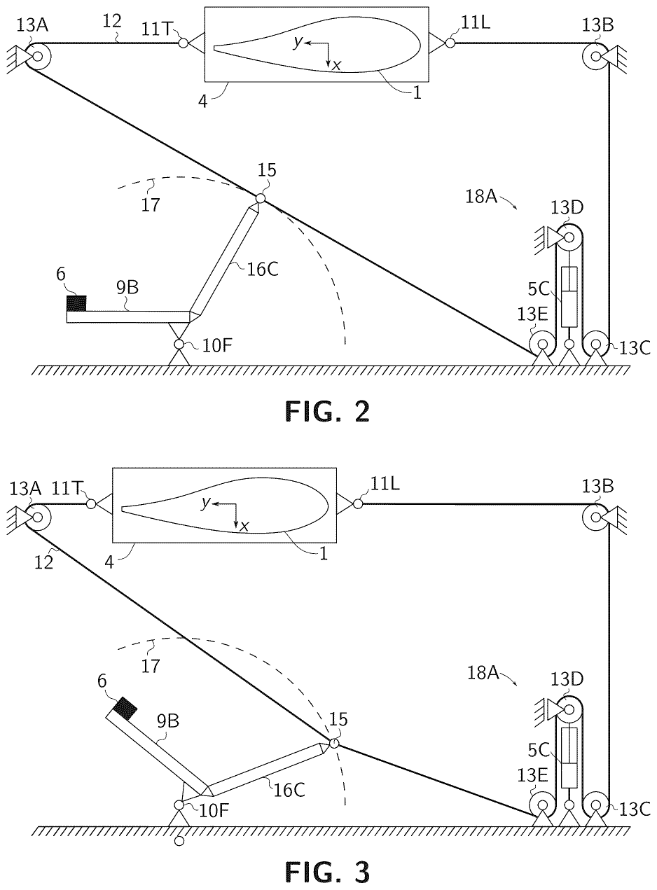

FIGS. 2-3 an embodiment of the test arrangement with a tensioning device and a movable mass with a lever arm,

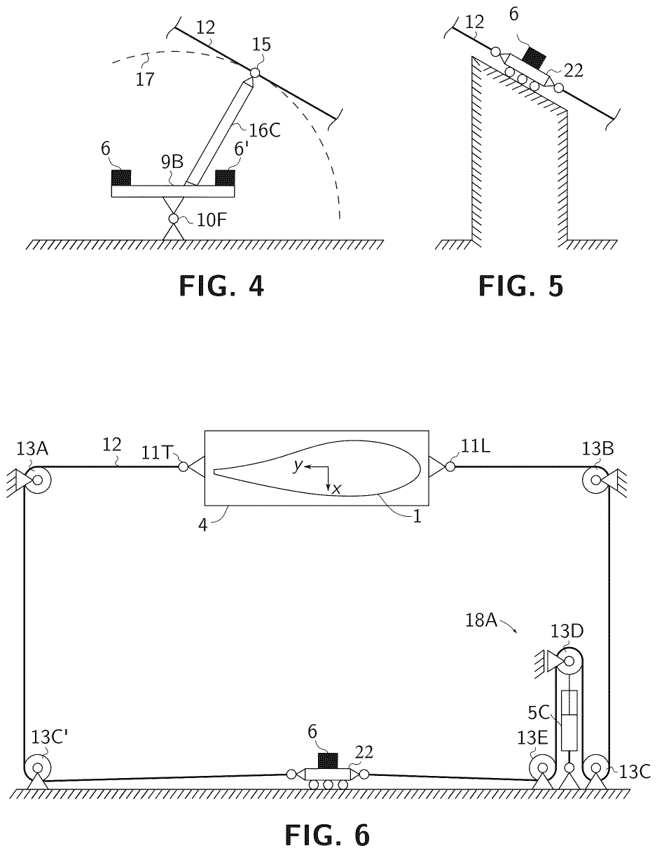

FIGS. 4-5 embodiments of moving masses,

FIG. 6 an embodiment of the test arrangement with a tensioning device and a horizontally displaceable moving mass,

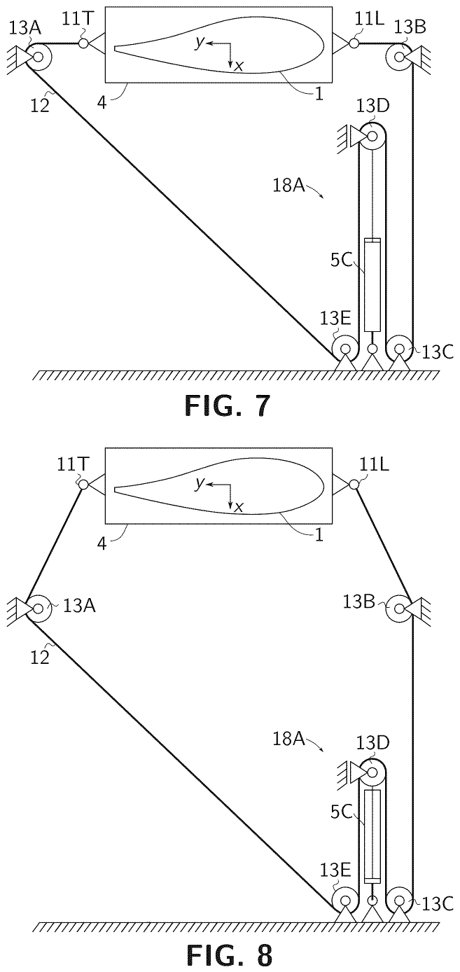

FIGS. 7-8 one embodiment of the test arrangement with a tensioning device,

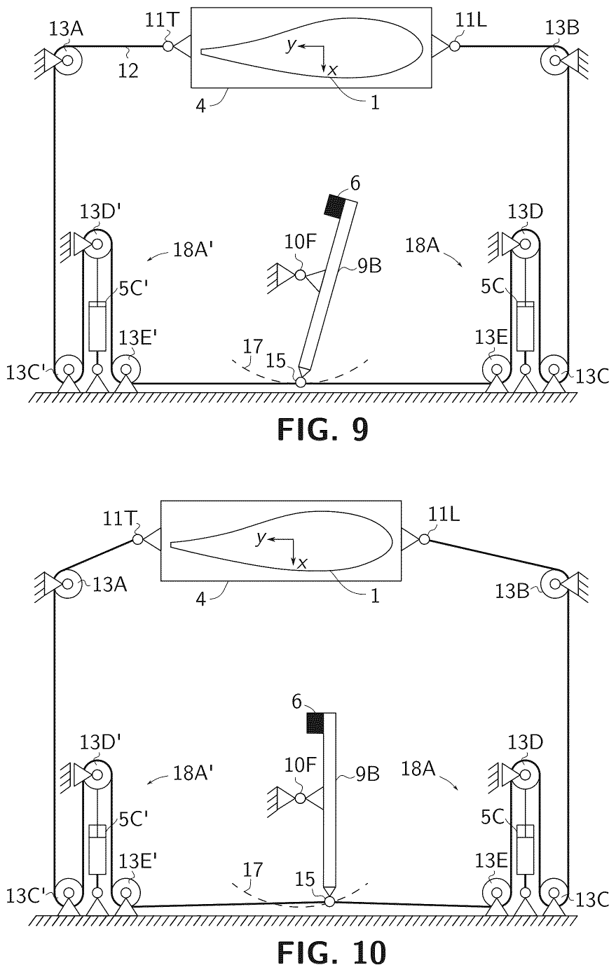

FIGS. 9-10 an embodiment of the test arrangement with two tensioning devices and a movable mass,

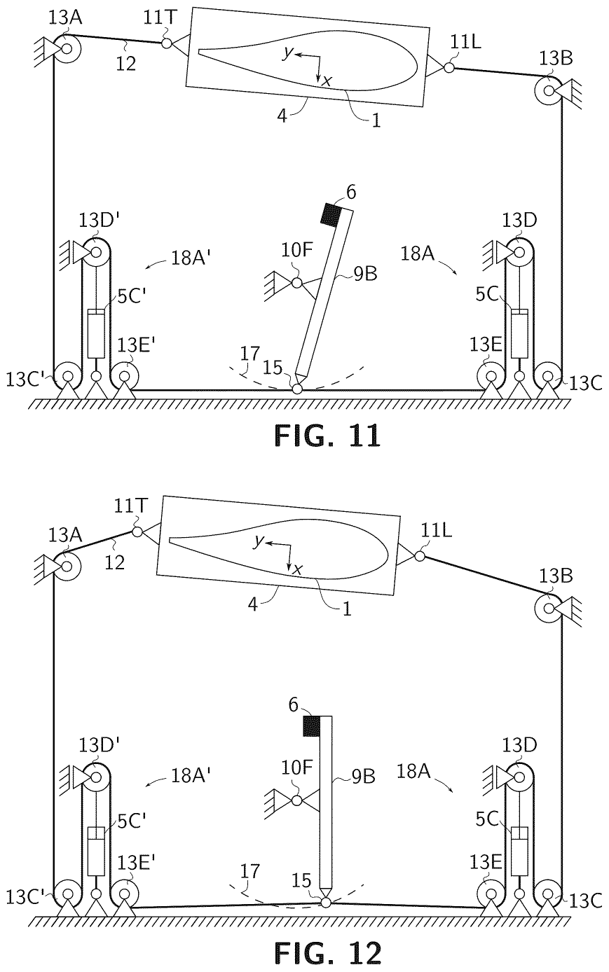

FIGS. 11-12 one embodiment of the test arrangement with deflection rollers arranged at different heights,

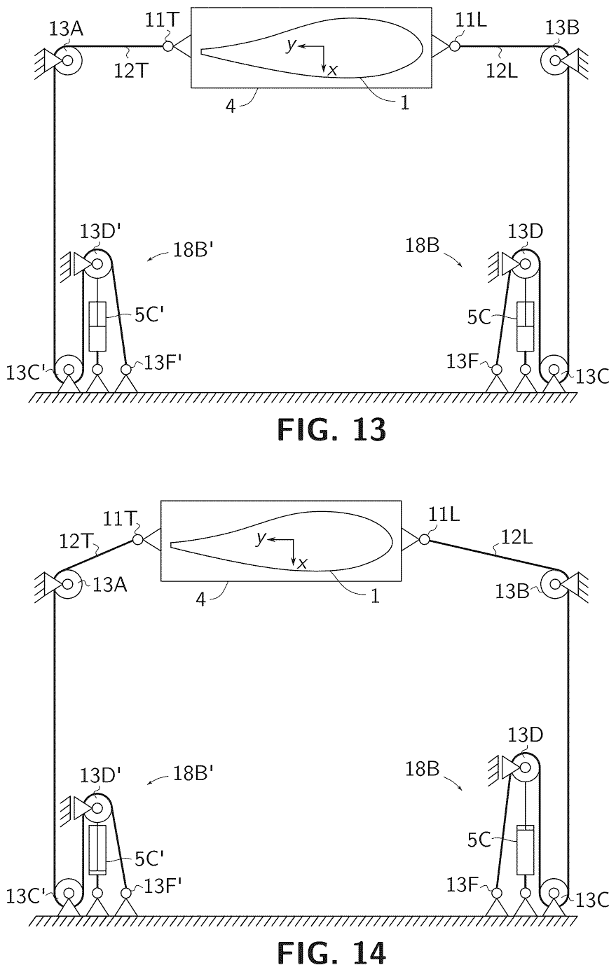

FIGS. 13-14 an embodiment of the test arrangement with two fixed cables, and

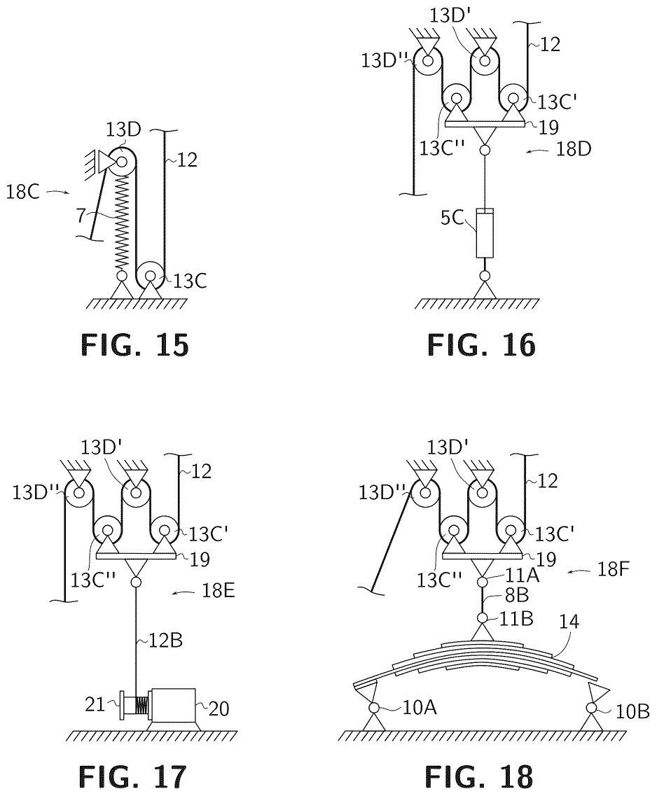

FIG. 15-18 embodiment of tensioning devices.

FIG. 1 shows a device for testing an elongated test specimen 1. The test specimen 1 in the form of a rotor blade for a wind turbine is clamped at a clamping point 1′ in a clamping device 2 of the device so that it extends lengthwise from the clamping device 2 in a longitudinal direction with a horizontal directional component.

The devices according to the application include at least one actuator 5A, 5B to deflect the test specimen.

Two actuators are shown, each connected to a base 3, wherein a first actuator is arranged to deflect the test specimen in a first deflection orientation and a second actuator is arranged to deflect the test specimen in a second deflection orientation across the first deflection orientation.

The first actuator is designed as a vertical actuator 5A, which can be actuated vertically and is connected to the base 3 via a first joint 11N and to a load frame 4A arranged on the test specimen via a second joint 11M.

The second actuator is configured as a horizontal actuator 5B to deflect the test specimen 1 in a second deflection orientation with a horizontal directional component. This horizontal actuator 5B can also be actuated vertically and is connected to the base via a first joint 11N and to a horizontally extending lever arm 9C via a second joint 11K. This lever arm 9C is then mounted on a hinge 10C at an end facing away from the actuator, so that it can be swivelled in relation to the base, and an angled beam 16A extends vertically (90° to the lever arm 9C) from this end to the test specimen's height, where the angled beam 16A is then in turn connected to the load frame 4A in an articulated manner via a substantially horizontal rod 8C and a joint 11J.

The embodiments explained in the following figures have, for example, one or both of these actuators. It should be understood that the actuators'exact embodiment is shown here only by way of example, and that vertical and horizontal actuators can also be differently designed.

A special feature of the test stand presented can be seen in the cable 12, which is attached between the actuators and a tip, i.e. to one of the clamping points 1′, opposite the end of the test specimen 1, via a further load frame 4 on the test specimen 1. Additionally or alternatively, one or more cables can also be arranged between clamping point 1′ and the actuators or between the actuators themselves and attached to the test specimen.

A first deflection roller 13A is arranged on a first side of the test specimen 1, so that a first cable section of the cable 12 can be guided over the first deflection roller 13A to a first lateral point of application 11L on the load frame 4 for the test body and connected to the first point of application 11L.

A second deflection roller 13B is arranged on a second side of the test specimen 2, opposite the first side, so that a second cable section of the cable 12 can be guided over the second deflection roller 13B to a second lateral point of application on the load frame 4 and connected to the second point of application, the second lateral point of application being opposite the first lateral point of application. A tensioning device 18A with a tensioning actuator 5C is used to tension the cable 12 and thus the first and second cable sections.

When using the system shown in FIG. 1, the test specimen is typically displaced via actuators 5A and/or 5B, with the first and second cable sections being tensioned by the tensioning device 18A. The tensioning device 18A can be configured as an active tensioning device in which the actuator 5C or a motor is adjustable. In one method, the deflection can be monitored and the deflection actuators 5A, 5B and the tensioning actuator 5C can be controlled. If, for example, only small vertical deflections are expected, it may be sufficient to preload the actuator 5C and to hold it still, acting only through the compliance of the cable itself.

FIG. 1 shows a possible cable configuration purely as an example. This configuration is also shown in detail in FIGS. 2 and 3 in a sectional view. Other cable configurations are also envisaged as part of this application, which, for example, result from FIGS. 4 to 18 and which may be present in addition to or as an alternative to the arrangement in FIG. 1.

In possible embodiments, the test specimen 1 is not prestressed, i.e. it is not moved out of its zero position by the cable arrangement. In other words, the forces acting on the cable through the opposing cable sections cancel each other out in the initial position, and the cable only begins to act on the test specimen when a deflection occurs. In some potential embodiments, however, the test specimen can also be prestressed in the direction of flapwise and/or in the edgewise direction by the cable arrangement.

FIGS. 2-3 show an embodiment of the test arrangement with a tensioning device and a movable mass with a lever arm. It is particularly advantageous when used for uniaxial testing in the horizontal pivot direction.

In this case, viewed from the test specimen, the tensioning device 18A and a movable mass 6 engage with the cable behind the deflection rollers 13A, 13B.

The tensioning device 18A is configured to tension the first and second cable sections and engages a third cable section located between the first and second deflection rollers, this third cable section being located behind the two deflection rollers 13A, 13B when viewed from the test specimen. This tensioning device includes a tensioning actuator 5C that is anchored to the base 3 and tightens the cable upwards, as well as a plurality of other deflection rollers 13C, 13D, 13E that guide the cable over the tensioning actuator 5C.

When using the system shown in FIGS. 2 and 3, for example, the test specimen is only deflected via the horizontal actuator 5B, whereby the first and second cable sections are tensioned by the tensioning device 18A. If uniaxial testing in the edgewise direction is planned, the vertical actuator can be dispensed with.

In the embodiment shown in FIGS. 2 and 3, the movable mass 6 is also connected to the cable 12, which is set in motion when the test specimen is horizontally deflected. The movable mass is supported at one end of a lever arm 9B, which is connected to the base via a hinge 10F at a point spaced from the mass 6, allowing it to pivot. At one of the ends of the lever arm 9B, opposite mass 6, an angled beam 16C is connected to the lever arm 9B, forming an angle of 110°-120° with the lever arm 9B, for example. The angled beam 16C acts on a connection point 15, e.g. via a cable clamp on the cable 12. A preload is applied to the cable by mass 6, on which the weight force engages.

When the test specimen moves horizontally, for example in the positive y-direction (in the rotor blade's edgewise direction), as shown in FIGS. 2 and 3, the connection point 15 moves in a circular travel path 17. This sets the mass 6 in motion, creating inertial forces that are transmitted to the test specimen via the angled beam and the cable.

The angled beam 16C is preferably aligned at about 90° to the cable 12 in the initial undeflected position. By choosing a long angled beam 16C, the radius of the travel path 17 is increased so that it approximates the linear cable section from 13A to 13E.

The tensioning actuator 5C, for example, is adjusted or controlled such that the cable 12 remains in the pivot direction under a defined minimum prestress during a cyclic horizontal excitation over an entire oscillation period during a dynamic excitation of the test specimen in or near its system natural frequency. This can be used to prevent the cable from becoming slack or sagging at any point. FIG. 2 shows the undeflected state of the test specimen and FIG. 3 the correspondingly deflected state in the edgewise direction. It can be seen that the cable is deflected at the connection point 15 along the travel path 17 and elongated between 13A and 13E. This cable elongation can be compensated for with an active cable elongation compensator, such as the actuator 5C. This is clearly visible in the figure showing the stroke's reduction. Even if uniaxial horizontal excitation is intended, the test specimen may be deflected in the vertical direction. When the test body 1 is deflected in a direction with a vertical directional component, a tension is applied to the first cable section and the second cable section if the first and second cable sections are connected to the test specimen, the at least one tensioning device 18A tensioning the first and second cable sections. This tension can exert a restoring force on the test specimen, which can be adjusted by the distance between the deflection rollers 13A and 13B. For example, in the arrangement consisting of FIGS. 2 and 3, a relatively large distance between the deflection rollers 13A and 13B has been chosen as a result of which a restoring force is low, for example, or is almost eliminated, especially for slight vertical deflections. In contrast to this, a small distance is selected in FIGS. 7 and 8, whereby a strong restoring force can be provided. This will also be described in more detail later with reference to FIGS. 7 and 8.

The arrangement of FIGS. 2 and 3 can therefore be used to apply the inertial forces, which are provided in a targeted manner by the swinging mass 6 for a horizontal deflection in the edgewise direction. The device is therefore particularly suitable for uniaxial testing in the edgewise direction. In this case, having large cable lengths between the first deflection roller 13A and the point of application 11T, as well as between the second deflection roller 13B and the point of application 11L, can minimise parasitic vertical restoring forces if any deflections arise from the portion of flapwise direction, if these are unwanted in the test.

FIGS. 4 and 5 show further possible embodiments of the above-mentioned movable mass 6. These alternatives, as well as the movable mass of FIGS. 2-3, are used, for example, in devices in which the first and second cable sections are connected to each other such that they act as one cable, i.e., in which the at least one cable 12 comprises a cable 12 and both the first cable section and the second cable section are sections of this first cable 12, so that the first cable 12 is guided over the first deflection roller 13A and the second deflection roller 13B and can be connected to the first and second point of application, or in which at least one cable 12 comprises a first cable 12 and a second cable 12A, the first cable section being a section of the first cable 12 and the second cable section being a section of the second cable 12A, the first and second cables being connected to one another.

To do this, the cable or the two cables are usually arranged such that it runs from the first lateral point of application to the first deflection roller 13, and, as seen from the angle of the test specimen 1, after the first deflection roller, the movable mass 6 and the tensioning device 18 engage on the at least one cable 12, the at least one cable runs to the movable mass 6 and the tensioning device 18 after the movable mass and the tensioning device 18 to the second deflection roller 13A and from the second deflection roller (13B) to the second lateral point of application.

FIGS. 4 and 5 now show only a section of the cable between the first deflection roller 13A and the tensioning device 18A.

FIG. 4 shows a device in which two movable masses 6, 6′ are mounted on a hinge 10F to enable them to swing. They are mounted at opposite ends of a bar, thus forming a double lever arm 9B, one to the right of hinge 10F and one to the left of hinge 10F. This means that the masses 6, 6′ can be arranged such that, in the starting position shown, they are in equilibrium and do not therefore exert a constant preload in the form of weight forces via the cable in the test specimen's edgewise direction, unlike the arrangement shown in FIGS. 2 and 3. The masses 6, 6′ are connected to the at least one cable 12 via an angled beam 16C attached to the lever arm bar 9B. If the test specimen is subjected to cyclic horizontal deflection, for example, the two movable masses 6, 6′act as inert masses, FIG. 5 shows an arrangement of a movable mass in which the movable mass 6 is mounted, thus enabling it to slide along the at least one cable 12. It is mounted on rollers on an inclined surface (but can also be mounted on runners or rails, for example). The mass 6 is located on a carriage 22, which is attached between two cables so that these two cables act as a single cable.

In this case, the movable mass 6 is arranged such that it undergoes a motion when the test specimen is deflected in a direction with a component along the cable, i.e. with a horizontal component, which causes asymmetrical tension on the first cable section and second cable section (e.g. only causing tension on one of the cable sections). Due to the inclined arrangement of the movable mass 6, an additional component of the weight force of the movable mass 6 engages with the cable, causing static tension at the first or second lateral point of application, by which the test specimen can undergo a constant deflection in the tension's direction.

FIG. 6 shows a further configuration with a movable mass 6. For a better understanding, here is the entire section through the arrangement, similar to that shown in FIGS. 2-3. The arrangement is similar to that shown in FIG. 5 in that the at least one cable 12 comprises a first cable and a second cable, the first cable section being a section of the first cable and the second cable section being a section of the second cable, the first and second cables being connected to each other by the carriage 22 that carries the movable mass 6. Here too, the movable mass 6 is mounted on rollers (or alternatively runners, rails, etc.) so that it can slide along the at least one cable 12 and undergoes a motion when the test specimen is deflected in one direction with a component along the cable (e.g. with a horizontal component). However, the movable mass 6 is designed as horizontally movable masses that is mounted in a supporting manner, so that a weight force engaging on the movable mass 6 does not cause any tension at the first or second lateral point of application. For example, to avoid any tension in the rest position, the arrangement can be limited to such movable masses 6 as shown in FIG. 4. To be able to move carriage 22 horizontally, the example shows an additional deflection roller 13C′ to bring the cable to the height of the deflection roller 13E of the clamping device 18A.

FIGS. 7 and 8 show another sectional view of a possible arrangement that can be advantageously used to uniaxially test in the flapwise direction (vertical deflection). The 18A tensioning device engages on the cable between the first deflection roller 13A and the second deflection roller 13B without any additional moving masses 6. The deformation of the test specimen 1 in the flapwise direction changes the cable's angle of application at the attachment points and joints 11T, 11L, resulting in a restoring force against the flapwise deformation. The distance between the first deflection roller 13A and the first joint 11T or between the second deflection roller 13B and the second joint 11L is kept as small as possible (or, for larger distances, the cable force is increased), so that even with small flapwise deformations, the force of the cable acts mainly in the flapwise direction x and the cable force component in the edgewise direction y is minimised. To compensate for lengthening the cable when the test specimen is deflected, the tensioning element has to travel a long way (as shown in FIG. 8). In the arrangement shown, the displacement corresponds approximately to the test specimen's vertical deflection. Without this travel path, the cable would not be able to lengthen accordingly, causing the cable tension and thus the restoring force to become too great, hindering the required test specimen's deflection and/or causing the cable to exceed its load limits. The tensioning actuator 5C must travel a relatively long path to maintain the cable tension so that the test specimen 1 can be deflected far (as shown in FIG. 8). The 5C tensioning actuator regulates the acting spring force (restoring force). The cable's elasticity can be taken into account when controlling or regulating the clamping actuator 5C, and in particular can be used advantageously for a spring effect, whereby less stroke in the actuator 5C may be required.

FIGS. 9-10 show a test embodiment of the test arrangement with two tensioning devices 18A, 18A′ and a movable mass 6, which is particularly suitable for biaxial excitation. Similarly to FIGS. 2 and 3, the movable mass 6 is attached to a lever arm 9B, which is pivotally mounted by a hinge 10F. Two similarly constructed tensioning devices 18A, 18A′, which engage on both sides of the movable mass arrangement on the cable 12, on the left and on the right, guide the cable, starting from the respective deflection rollers 13A, 13B, at the same height so that it extends horizontally between the two tensioning devices 18A, 18A'. The cable is configured such that it runs from the first lateral point of application to the first deflection roller 13A, and, as seen from the test specimen 1, after the first deflection roller 13, the first tensioning device 18A′ on the at least one cable 12, then the movable mass 6 engages the cable 12, then the second tensioning device 18A engages the cable 12 and the cable runs from the second tensioning device 18A to the second deflection roller 13B and from the second deflection roller 13B to the second lateral point of application. The bottom end of lever arm 9B is attached to the cable at connection point 15. The movable mass 6 is located at the upper end of the lever arm 9b. When there is horizontal deflection, the connection point moves along the circular arc-shaped travel path 17.

In contrast to the arrangement shown in FIGS. 2 and 3, the deflection rollers 13A and 13B are located close to the test specimen, so that a comparatively large angle is introduced into the cable sections between 13A and 11T and between 13B and 11L when the test specimen 1 is vertically deflected, resulting in a significant vertical restoring force. In the device shown in FIGS. 9 and 10, it is also possible to advantageously minimise parasitic forces, for example by appropriately adjusting the distance from the first deflection roller 13A to the first joint 11T, or the distance from the second deflection roller 13B to the second joint 11L. The advantage is that the movement of the decoupled movable mass 6 is not influenced by the test specimen's movements in the flapwise direction. It is the second tensioning device 18A′ that makes this possible. The two tensioning devices 18A, 18A′ compensate symmetrically for the change in the cable's length, with the elongation being divided between the two tensioning actuators 5C, 5C′.

The device can, for example, be configured such that the test specimen 1 extends in an undeflected state through a connecting line from the first deflection roller 13A to the second deflection roller 13B, so that the first cable section and the second cable section can be connected to the test specimen 1 such that tension transmitted by the first cable section and tension transmitted by the second cable section engage in opposite directions, in particular in exactly opposite directions.

It is also possible, however, for the test specimen 1 to extend in an undeflected state outside of a connecting line from the first deflection roller 13A to the second deflection roller 13B, so that the first cable section and the second cable section are connected to the test specimen 1 such that any tension transmitted by the first cable section and any tension transmitted by the second cable section exert a preload, in particular in a direction with a vertical directional component, on the undeflected test specimen 1.

In the cases of the previous figures, the deflection rollers 13A and 13B were shown at the same height. However, it is also possible to mount the deflection rollers 13A, 13B at different heights, as shown in FIGS. 11 and 12. The device corresponds otherwise exemplarily to that from FIGS. 9 and 10.

This arrangement can be used to configure the device so that the test specimen 1 extends in an undeflected state through a connecting line from the first deflection roller 13A to the second deflection roller 13B, so that the first cable section and the second cable section can be connected to the test specimen 1 in such a way that any tension applied by the first cable section and any tension applied by the second cable section act in exactly opposite directions, wherein this tension can engage in the pivot direction, which, for example, does not correspond exactly to a horizontal direction. This allows examination of the blade properties and blade geometry at the location of the load frame 4, whereby a corresponding adjustment can be made by positioning the height of the two deflection rollers 13A, 13B, which takes into account the desired loading.

FIGS. 13 and 14 show a section through another possible arrangement that can be used in the device to test an elongated test specimen 1. It differs from the previous arrangements in that the at least one cable includes a first cable 12T and a second cable 12L, the first cable section being a section of the first cable 12T such that the first cable 12T is connected to the first point of application and the second cable section being a section of the second cable 12L such that the second cable 12L is connected to the second point of application. The device may have a first cable attachment 13F to attach the first cable 12T and a second cable attachment 13F to attach the second cable 12L. This provides two separate and independently engaging cables. The at least one tensioning device 18 comprises a first tensioning device 18B′ and a second tensioning device 18B. The first tensioning device 18B′ engages between the first deflection roller 13A and the first cable attachment 13F′ on the first cable 12T and can thus tension the first cable 12T. The second tensioning device 18B engages between the second deflection roller 13B and the second cable attachment 13F on the second cable 12L and can thus tension the second cable 12L.

The arrangement allows control during uniaxial or biaxial excitation. E.g., the force introduction for the edgewise direction (“active mass”) can be actively controlled by controlling or regulating the tensioning actuators 5C, 5C′, which can be used to simulate an effect similar to that of the decoupled mass, but the flapwise direction's restoring force can also be adjusted and controlled. In particular, force amplitude and the point in time when it is applied can be adjusted via controllers.

FIGS. 15 to 18 show embodiments for the clamping devices. The above figures show tensioning devices 18A, 18A′, 18B, 18B′, each of which comprises a tensioning actuator and deflection rollers. In all embodiments, the tensioning devices shown in FIGS. 15 to 18 can be used as an alternative or in addition.

FIG. 15 shows a tensioning device 18C in which the tensioning actuator 5C is essentially replaced by a tension and compression spring 7. This design can be advantageous for simply maintaining a minimum tension prestress as well as for compensating for deflections, as discussed in connection with FIGS. 2 and 3, for example.

FIG. 16 shows a tensioning device 18D in which the tensioning actuator 5C is connected to a pulley arrangement. The pulley arrangement here includes four deflection rollers 13C′, 13D′, 13C″, 13D″; two of which, deflection rollers 13C′, 13C″, are attached to a crossbar 19 connected to the tensioning actuator 5C. Of course, fewer or more than four deflection rollers are also possible. In this way, a cylinder path of the tensioning actuator is halved, thirded, quartered, etc. depending on the number of deflections (halved in the example shown). This can save on installation space and energy, for example, when using a hydraulic actuator.

FIG. 17 shows an embodiment, in which the tensioning device 18E comprises a cable 12B and a cable winch 21 with a motor 20. The motor 20 can be an electric motor and can have a gearbox, for example. The cable is attached to a crossbar 19 of a pulley (see the explanations for FIG. 16). The motor may be regulated to apply the desired tension to the at least one cable 12 of the test specimen via the cable 12B of the cable winch arrangement.

FIG. 18 shows a tensioning device 18F in which a pulley's crossbar 19 (see again FIG. 16) is connected to a prestressed leaf spring 14. This prestresses the cable 12 of the test arrangement. For this purpose, the leaf spring is configured in its operation such that it remains permanently deflected under tension. Thanks to the shorter path created by the pulley, this leaf spring can be designed to be relatively compact, i.e. it is shorter, which results in a reduced mass (which counteracts the spring effect) and less material usage, and thus lower costs.

### LIST OF REFERENCE SIGNS

1 test specimen
1′ clamping point
2 clamping device
3 base
4 load frame
5A vertical actuator
5B horizontal actuator
5C tensioning actuator
6 mass
7 spring
8 rod
9 lever arm
10 hinge
11 joint
12 cable
13A first deflection roller
13B second deflection roller
13F′ first cable attachment
13F′ second cable attachment
14 leaf spring
15 connection point
16 angled beam
17 travel path
18 tensioning device
19 crossbar
20 motor
21 cable winch
22 carriage

1. A device to test an elongated test specimen, comprising:
a clamping device to clamp the elongated test specimen such that it extends with a horizontal directional component lengthwise from the clamping device in a longitudinal direction;
at least one actuator to deflect the elongated test specimen;
at least one cable;
a first deflection roller arranged on a first side of the elongated test specimen, so that a first cable section of the at least one cable is be-guided over the first deflection roller to a first lateral point of application on the elongated test specimen or a load frame for the elongated test specimen and is connected to the first lateral point of application;
a second deflection roller arranged on a second side of the elongated test specimen opposite the first side, so that a second cable section of the at least one cable is guided over the second deflection roller to a second lateral point of application on the elongated test specimen or the load frame for the elongated test specimen and is connected to the second lateral point of application, the second lateral point of application being opposite the first lateral point of application; and
at least one tensioning device to tension the first cable section and the second cable section.

2. The device according to claim 1, wherein the at least one actuator comprises a first actuator to deflect the elongated test specimen in a first deflection orientation and a second actuator to deflect the elongated test specimen in a second deflection orientation perpendicular to the first deflection orientation.

3. The device according to claim 1, wherein the at least one actuator comprises:
a vertical actuator to deflect the elongated test specimen with a vertical directional component, wherein when the elongated test specimen is being deflected in a vertical direction, tension is exerted on the first cable section and the second cable section when the first cable section and the second cable section are connected to the elongated test specimen with the at least one tensioning device tensioning the first cable section and the second cable section such that a restoring force is exerted on the deflected elongated test specimen.

4. The device according to claim 1, wherein the at least one actuator comprises:
a horizontal actuator to deflect the elongated test specimen in a second deflection orientation with a horizontal directional component.

5. The device according to claim 1, wherein the at least one cable comprises:
a first cable:
a second cable, wherein the first cable section is a section of the first cable, so that the first cable is connected to the first lateral point of application, wherein the second cable section is a section of the second cable, so that the second cable is connected to the second lateral point of application;
a first cable attachment to attach the first cable; and
a second cable attachment to attach the second cable, wherein the at least one tensioning device comprises a first tensioning device and a second tensioning device, wherein the first tensioning device engages the first cable between the first deflection roller and the first cable attachment, and wherein the second tensioning device engages the second cable between the second deflection roller and the second cable attachment.

6. The device according to claim 5, wherein, i) the at least one cable comprises a first cable, wherein both the first cable section and the second cable section are sections of the first cable, so that the first cable is guided over the first deflection roller and the second deflection roller and is connected to the first lateral point of application and the second lateral point of application, or wherein ii) the at least one cable comprises a first cable and a second cable, the first cable section being a section of the first cable and the second cable section being a section of the second cable, and wherein the first cable and the second cable are connected to each other.

7. The device according to claim 6, wherein the at least one cable is connected to at least one movable mass.

8. The device according to claim 7, wherein the at least one movable mass is at least one of: i) pivotally mounted via a hinge, ii) connected to the at least one cable via a lever arm, iii) connected to the at least one cable via an angled beam, or iv) is mounted such as to be longitudinally displaceable with respect to the at least one cable.

9. The device according to claim 7, wherein the at least one movable mass is arranged to undergo a motion upon deflection of the elongated test specimen in a direction having a component along the at least one cable, wherein the component along the at least one cable is a horizontal component, which causes an asymmetrical tension on the first cable section and the second cable section.

10. The device according to claim 7, wherein the at least one movable mass is arranged such that a weight force engages on the at least one movable mass, via which static tension is applied to the first lateral point of application or the second lateral point of application, by which the elongated test specimen undergoes a constant deflection towards the static tension.

11. The device according to claim 7, wherein the at least one movable mass comprises at least one of, one or more horizontally movable masses or one or more masses supportively mounted, so that a weight force engaging on the at least one movable mass does not cause any tension at the first lateral point of application or the second lateral point of application.

12. The device according to claim 7, wherein the at least one cable being arranged such that it runs from the first lateral point of application to the first deflection roller, wherein the at least one movable mass and the at least one tensioning device engage on the at least one cable after the first deflection roller, as seen from the elongated test specimen , wherein the at least one cable runs after the at least one movable mass and the at least one tensioning device to the second deflection roller and from the second deflection roller to the second lateral point of application.

13. The device according to claim 7, comprising:
a first clamping device; and
a second clamping device, wherein the at least one cable is configured such that it runs from the first lateral point of application to the first deflection roller, and, as seen from the elongated test specimen, after the first deflection roller, the first tensioning device engages the at least one cable, then the at least one movable mass engages the at least one cable, then the second tensioning device engages the at least one cable and the at least one cable runs from the second clamping device to the second deflection roller and from the second deflection roller to the second lateral point of application.

14. The device according to claim 1, wherein the at least one tensioning device includes a tensioning actuator, wherein the tensioning actuator is at least one of: i) an electric, hydraulic or pneumatic actuator, ii) a motor, iii) a cable winch, iv) a spring, v) a leaf spring, vi) one or more deflection rollers, or vii) a pulley.

15. The device according to claim 1, wherein the at least one tensioning device is an active tensioning device comprising at least one of a motor or an actuator, wherein at least one of the motor [and/]or the actuator are at least one of controllable or adjustable.

16. The device according to claim 1, wherein the first deflection roller and the second deflection roller are arranged at 0 a same height.

17. The device according to claim 1, wherein the elongated test specimen extends in an undeflected state through a connecting line from the first deflection roller to the second deflection roller, so that the first cable section and the second cable section are connected to the elongated test specimen such that any tension transmitted by the first cable section and any tension transmitted by the second cable section engage in opposite directions.

18. The device according to claim 1, wherein the elongated test specimen extends in a non-deflected state outside a line connecting the first deflection roller to the second deflection roller, such that the first cable section and the second cable section are connected to the elongated test specimen such that any tension applied by the first cable section and any tension applied by the second cable section exert a prestress, in a direction with a vertical directional component, on the undeflected elongated test specimen.

19. A system for testing an elongated test specimen, comprising:
a device comprising:
a clamping device to clamp the elongated test specimen such that it extends with a horizontal directional component lengthwise from the clamping device in a longitudinal direction:
at least one actuator to deflect the elongated test specimen:
at least one cable;
a first deflection roller arranged on a first side of the elongated test specimen, so that a first cable section of the at least one cable is guided over the first deflection roller to a first lateral point of application on the elongated test specimen or a load frame for the elongated test specimen and is connected to the first lateral point of application;
a second deflection roller arranged on a second side of the elongated test specimen opposite the first side, so that a second cable section of the at least one cable is guided over the second deflection roller to a second lateral point of application on the elongated test specimen or the load frame for the elongated test specimen and is connected to the second lateral point of application, the second lateral point of application being opposite the first lateral point of application; and
at least one tensioning device to tension the first cable section and the second cable section;
wherein the system further comprises:
the elongated test specimen, wherein the elongated test specimen is clamped in the clamping device such that it extends lengthwise from the clamping device in the longitudinal direction with the horizontal directional component, with the first cable section connected to the first lateral point of application and the second cable section connected to the second lateral point of application.

20. The system for testing an elongated test specimen according to claim 19, wherein the elongated test specimen is deflected by the at least one actuator, and wherein the first cable section and the second cable section are tensioned by the at least one tensioning device.

21. The system according to claim 20, wherein the elongated test specimen is deflected in a direction with a vertical directional component, so that a restoring force is exerted on the vertically deflected elongated test specimen by the at least one cable.

22. The system according to claim 20, wherein the elongated test specimen is deflected in a direction having a horizontal directional component, and wherein the at least one cable tolerates the horizontal deflection and runs over the first deflection roller and the second deflection roller in response to the deflection, and wherein the deflection is influenced by at least one movable mass connected to the at least one cable.
